(19) United States
(12) Patent Application Publication
(10) Pub. No.: US 2021/0354373 A1
(43) Pub. Date: Nov. 18, 2021

(54) APPARATUS COMPRISING A MATERIAL MIXER TO PROVIDE MATERIAL TO A 3D PRINTER

(71) Applicant: HEWLETT-PACKARD DEVELOPMENT COMPANY, L.P., Spring, TX (US)

(72) Inventors: Pol FORNOS MARTINEZ, Sant Cugat del Valles (ES); Maria de las Mercedes BLANCO ROLLAN, Sant Cugat del Valles (ES); Ismael FERNANDEZ AYMERICH, Sant Cugat del Valles (ES)

(21) Appl. No.: 17/287,111

(22) PCT Filed: Apr. 24, 2019
(86) PCT No.: PCT/US2019/028940

§ 371 Date: Apr. 20, 2021

(51) Int. Cl. B29C 64/153; B29C 64/314; B29C 64/336; B29C 64/255; B33Y 10/00; B33Y 30/00; B33Y 40/10; B29C 64/393; B33Y 50/02

(52) U.S. Cl. CPC B29C 64/153; B29C 64/314; B29C 64/336; B29C 64/255; B29C 64/357; B33Y 30/00; B33Y 40/10; B29C 64/393; B33Y 50/02; B33Y 10/00

(57) ABSTRACT

An apparatus is described which comprise a material mixer to provide build material from at least a first build material supply and a second build material supply to a build unit of a 3D printer. The first build material and the second build material are mixed according to a mixing ratio. The apparatus further comprises a processor to determine the mixing ratio based on inputs indicating at least print job characteristics and material constraints.

### BACKGROUND

To reduce the cost of 3D (three-dimensional) printing it is known to reuse non-fused build materials in subsequent builds. The amount of non-fused build material will depend upon the specific 3D print job (for example the geometry of the print job).

Due to various factors, for example degradation during the print process, different materials for 3D printing have different recyclability. As such, in order to provide consistent build quality a mix ratio of recycled to fresh material is generally specified for each material used in a 3D printer. A supply of both fresh and recycled material may be maintained for use in the 3D printer so that the desired mix can be provided to the build unit of the 3D printer.

### BRIEF DESCRIPTION OF THE DRAWINGS

Various features of the present disclosure will be apparent from the detailed description which follows, taken in conjunction with the accompanying drawings, which together illustrate features of the present disclosure, and wherein:

FIG. 1 is a block schematic illustrating an example of a 3D printer material supply arrangement;

FIG. 2 is an example of a system for 3D build material supply;

FIGS. 3A and 3B are diagrams illustrating an example of material management in 3D printing.

### DETAILED DESCRIPTION

In one implementation, an apparatus may be provided for controlling the supply of material for use in the build unit of a 3D printer. The build unit may be removable with respect to the 3D printer or may be a fixed build unit. The apparatus may include a material mixer to provide build material from at least a first build material supply and a second build material supply to a build unit of a 3D printer. The first build material and the second build material may be mixed according to a mixing ratio. A processor may determine the mixing ratio based on inputs indicating at least print job characteristics and material constraints.

The build material may be fused in a bed in the 3D print build. Unfused build material from the bed may be used in subsequent 3D print builds as recycled build material. The use of recycled build material may reduce the build cost.

The build material may for example be a powder. Powdered build material may be used to refer to wet or dry powder, particulate materials, and granular materials. Powdered build material may be made from many suitable materials, for example, powdered metallic materials, powdered composite materials, powdered ceramic materials, powdered resin materials, powdered glass materials, powdered polymer materials and the like.

In some examples, powdered build material may be formed from, or may comprise, short fibers that may, for example, have been cut into short lengths from long strands or threads of material. Short fibers may be metallic fibers, polymer fibers, ceramic fibers, or other suitable fiber materials.

Examples of build materials for additive manufacturing include polymers, crystalline plastics, semi-crystalline plastics, polyethylene (PE), polylactic acid (PLA), acrylonitrile butadiene styrene (ABS), amorphous plastics, Polyvinyl Alcohol Plastic (PVA), Polyamide (e.g., nylon), thermo(setting) plastics, resins, transparent powders, colored powders, metal powder, ceramics powder such as for example glass particles, and/or a combination of at least two of these or other materials wherein such combination may include different particles each of different materials or different materials in a single compound particle. Examples of blended build materials include alumide, which may include a blend of aluminum and polyamide, and plastics/ceramics blends. Material constraints for different materials types and specific materials may be used in implementations.

The first build material and second build material may have different proportions of recycled powder. For example, the first build material may be pure fresh material and the second build material may be pure recycled material. In other implementations the first and second build materials could have different predetermined ratios of fresh and recycled material which may be combined to provide a range of mixing ratios of fresh and recycled material. Implementations may include further material supplies for example of additional fresh or recycled material or of different predetermined mixtures.

A method may comprise: receiving a 3D print job; providing at least a first build material supply and a second build material supply; and determining a mixing ratio of the at least first material supply and the at least second material supply. The mixing ratio may be based on inputs indicating at least print job characteristics and material constraints. The method may also include mixing build material in accordance with the mixing ratio and supplying the mixed build material to a build unit of a 3D printer.

In an implementation, a machine readable storage medium may comprise instructions executable by a processor to: receive a 3D print job; determine the mixing ratio of at least a first build material and a second build material based on inputs indicating at least print job characteristics and material constraints; and instruct the supply of mixed print material to the build unit of a 3D printer based upon said mixing ratio.

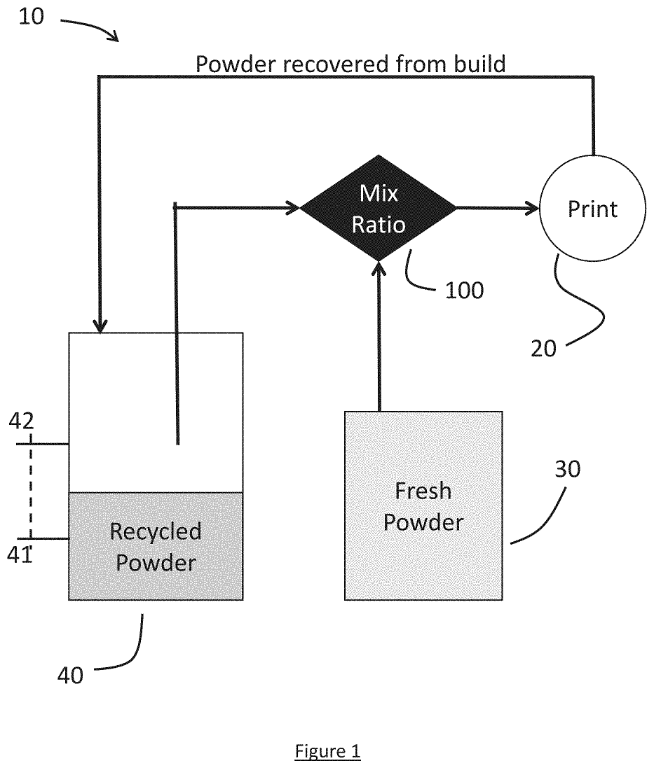

As shown in the example of FIG. 1 a 3D print system 10 may include a 3D printer 20, a mix apparatus 100 a supply of fresh powder 30 and a supply of recycled powder 40. The 3D printer may be any suitable 3D printer and may, for example, create objects by fusing powder on a layer-by-layer basis. The mix apparatus 100 may combine the fresh and recycled powder in a mix ratio and supply the mixed powder to the build unit of the 3D printer 20. After completion of a build unused powder is recovered from the build unit of the 3D printer 20 and returned to the recycled powder supply 40.

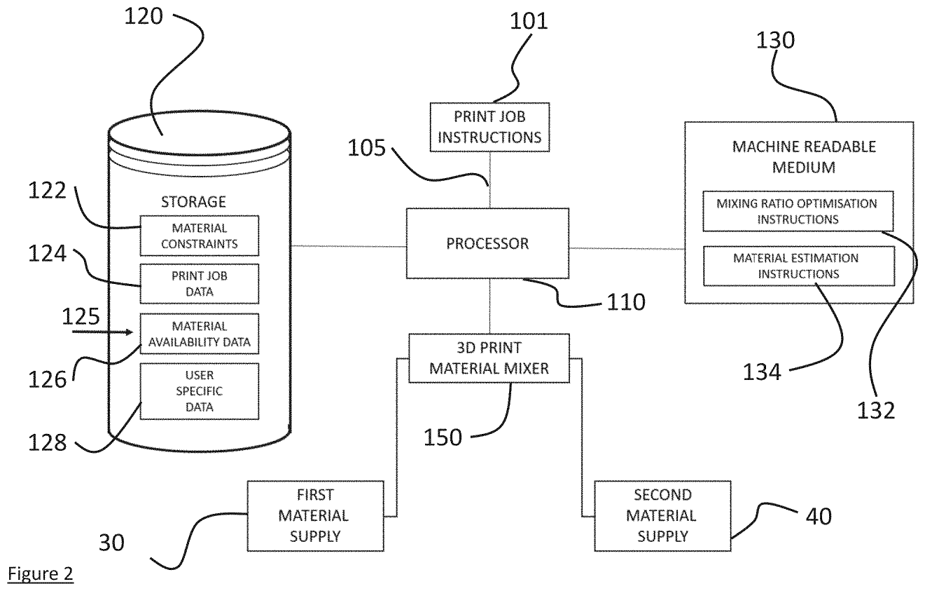

An implementation of the mix apparatus 100 is shown schematically in FIG. 2. The mix apparatus 100 has a processor 110 which includes an interface 105 to receive print job instructions 101. The processor 110 can be connected to a storage 120. The storage, for example, contains data related to the material constraints 122. A machine readable medium 130 may be provided and include instructions to be executed by the processor 110. The processor sends output to a 3D print material mixer 150 which combines build material from at least a first material supply 30 and a second material supply 40 to be provided to the build unit of a 3D printer.

The processor 110 may be a central processing unit (CPU), a semiconductor-based microprocessor or any other device suitable for retrieval and execution of instructions. As an alternative or in addition to fetching, decoding, and executing instructions, the processor 110 may include one or more integrated circuits (ICs) or other electronic circuits that comprise a plurality of electronic components for performing the functionality described herein. The functionality described herein may be performed by multiple processors. The processor 110 may provide a service to a single 3D printer or may be used for a plurality of 3D printers (and may be a cloud-based service). In one implementation, the processor 110 is part of the 3D printer 20, such as where the processor 110 manages additional operations of the 3D printer 20.

The processor 110 may communicate with the machine-readable storage medium 130. The machine-readable storage medium 130 may be any suitable machine readable medium, such as an electronic, magnetic, optical, or other physical storage device that stores executable instructions or other data (e.g., a hard disk drive, random access memory, flash memory, etc.). The machine-readable storage medium 130 may, for example, be a computer readable non-transitory medium. The machine-readable storage medium 130 may include mixing ratio optimization instructions 132 and material estimation instructions 134.

The storage 120 may be any convenient store and can without limitation include local files, web storage, databases and/or FTP servers. The storage 120 stores material constraints 122 which may, for example, include data for a range of commonly used 3D printing materials. For the, or each, specific 3D printing material the storage may include data defining an upper and lower threshold value for the mix ratio of recycled to fresh material desired to ensure acceptable 3D print quality.

The storage 120 may store print job data 124. Print job data may include specific job data 124 which is directly related to the print job instructions 101, and such data may therefore be updated by the processor 110 in response to the instructions 101. The print job data 124 may also include generic print related data such as data related to the relationship between print job height and print volume or data used to derive other relationships such as part density or surface area.

The storage 120 may also store information relating to material availability 126. For example, the storage may maintain a record of at least the current volume of material in the first build material supply 30 and the second build material supply 40. An interface 125 may be provided for supplying current information on the build material supply levels, for example from at least one sensor in at least one of the build material supplies. The second build material supply 40 may be a recycled material supply the level of which will vary as material is supplied to and recovered from the 3D printer build unit. Accordingly, in an implementation the material availability 126 may include a minimum 41 and maximum 42 threshold level of recycled material that is to be maintained in the second build supply 40. The maximum threshold level 42 may be physically limited by the volume of the supply 40. For efficient material use, the maximum threshold level 42 may be based upon the maximum potential recycled powder that may be needed by the user, this may equal the total volume of the 3D build units available to the user. The minimum threshold level 41 can be equal to the volume of a single build unit.

The storage 120 may also include user specific data 128. For example, the user specific data may include the number of 3D printer build units that the user has available for use with the material mixer 100. The user specific data 128 may also include data regarding the user's powder recovery approach. Powder recovery generally varies from user to user since it generally implies a degree of manual labor. A user can make a decision on whether to use a labor intensive approach, which will recover more build material to be recycled, or a less labor intensive approach, which will recover less build material to be recycled. The user's approach can be quantified as a re-use factor, which may be updated and iterated based upon actual powder use and recovery data over a series of print jobs.

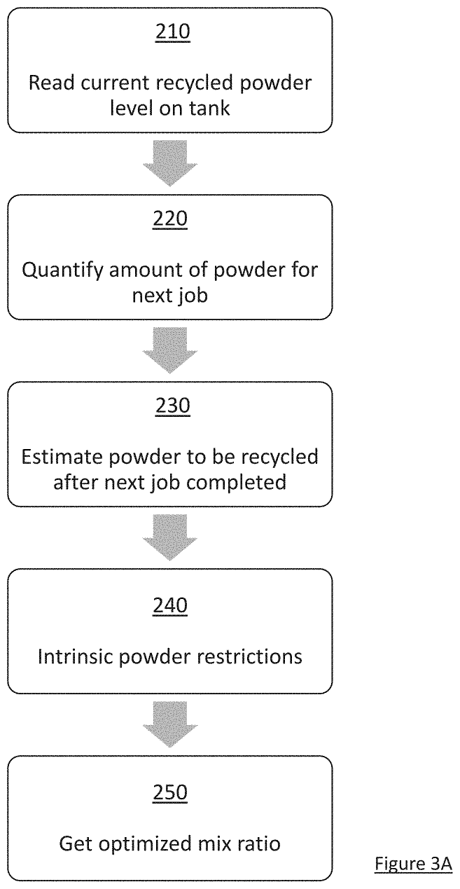

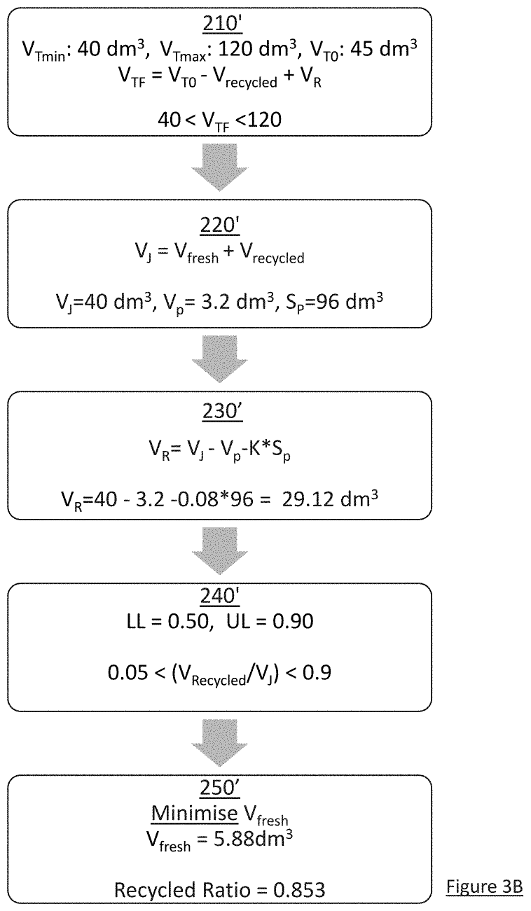

An implementation will now be described with reference to the process flow chart of FIG. 3A and the example flow of FIG. 3B. The example of FIG. 3B is based upon a user having 3 build units each having a 40 dm³ build volume and implementing a build job of 25 dm³. A 3D print job instruction 101 is triggered by a user and is sent to the processor 105 of the mixer 100. In blocks 210 to 230 the processor may carry out initial material estimation instruction. At block 210 (and 210′ for the example) the processor may read the current level of recycled powder (V_{TO}) in the second material supply 40 and confirm that this level is between the maximum (V^{Tmax}) and minimum (V_{Tmin}) levels. If the current level is outside of these ranges an alert or notification may be triggered prior to proceeding with the 3D print job.

At block 220, the processor can make an initial estimation of the quantity of material (Vⱼ) for the print job. The total quantity of material (Vⱼ) can be derived from the height of the build job (H) and the dimensions of the 3D build unit (since the process will generally fill the build unit with powder to the full height). An initial estimate of the quantity of fresh material (V_{Fresh}), from the first supply 30, and recycled material (V_{Recycled}) can be made in block 220. The print job characteristics may also be obtained by the processor 105 in block 220 and may be from a combination of the print job instructions 101 and the print job data 124. As seen in the example, the print job characteristics may include build job data relating to geometry and/or build density. The print job characteristic can include the volume of the parts in the job (V_{P}) and the total surface area of the job (S_{P}).

At block 230, the processor 110 makes an estimate of the recycled powder that will be available after completion of the current job (V_{TF}). The total after the job may be determined from the total before supplying the build unit (V_{TO}) less the volume of recycled powder for the current job (V_{Recycled}) plus the volume recovered after completion of the print job (V_{R}). To avoid the risk that there may be interruption to subsequent builds or excess powder which may needlessly be disposed of, the total recycled powder after the current job may be between the minimum (V_{Tmin}) and maximum levels (V^{Tmax}) for the second build material supply 40. As seen in the example implementation block 230′ to estimate the recycled powder that will be available after completion of the current job (V_{TF}) the processor may first calculate the powder to be recovered (V_{R}) from the 3D print job. This can be executed using the material estimation instructions and may be based upon the total powder volume for the 3D print job (V_{J}) less the total part volume in the print job (V_{P}). To provide a more accurate estimate an adjustment may also be made for accuracy or thoroughness of the recovery of powder and further deducted from the total powder volume for the 3D print job (V_{J}). In the implementation of FIG. 3B, the recovery adjustment can be calculated based upon the total surface area of the parts in the job (S_{P}) and a user factor (K) which is indicative of the user's approach to material recovery. The surface area of the parts Sₚ may also include allowance or factoring for the part geometry or complexity, for example factors which reduce the recovery may be stored in print job data 124 of the storage for use by the processor 110.

In block 240 of the implementation of FIG. 3 the processor 110 obtains the material constraints from the storage 120. The material constraints may include an upper limit (UL) and lower limit (LL) for the ratio of recycled powder for a specific material. The material constraint can be stored for a variety of material types and can provide a range for each material where part quality will be assured. The constraints for each material may depend upon a number of factors including one or more of the following examples: the presence of additives (such as flow aids) which may deteriorate during material processing; the effect of recycled powder on degradation (such as oxidation); changes in the melt temperature of the build material due to the presence of recycled material.

With the material constraints from block 240 the processor 110 of the implementation may, in block 250, use the mixing ratio optimization instructions 132 to obtain a mix ratio for the specific print job instructed. The resulting mix ratio may be provided from the processor 110 to the 3D material mixer 150. The mixing ratio optimization instructions can seek to minimize the volume of fresh material (V_{fresh}) used whilst staying within the limitations of the material constraints. This can ensure print job quality whilst also reducing the total cost to the user. When optimizing the mix ratio, the processor may also include constraints based upon the material availability and estimates derived in blocks 210 to 230, for example to ensure that the recycled material remains between the minimum and maximum thresholds.

As described above, implementations may enable an apparatus to provide a dynamic mix ratio derived by the processor for each 3D print job. The mix ratio can be non-fixed and does not need to be pre-specified in the print job instructions. In implementations the optimized mix ratio provided by the apparatus may reduce the usage of at least one of the build materials. The mixing ratio optimization in some implementations may minimize the use of one build material, for example minimize the fresh material.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

What is claimed is:

1. An apparatus comprising:
a material mixer to provide build material from at least a first build material supply and a second build material supply to a build unit of a 3D printer, the first build material and the second build material being mixed according to a mixing ratio; and
a processor to determine the mixing ratio based on inputs indicating at least print job characteristics and material constraints.

2. An apparatus as claimed in claim 1, further comprising a storage to store at least material constraints relating to at least one build material.

3. An apparatus as claimed in claim 2, wherein the storage stores upper and lower threshold values for the material mixture for at least one build material.

4. An apparatus as claimed in claim 1, wherein the apparatus further comprises an interface to obtain material availability data and the processor uses material availability as a further input.

5. An apparatus as claimed in claim 4, wherein the processor further estimates the powder availability after completion of the print job.

6. An apparatus as claimed in claim 1, wherein the processor determines the mixing ratio to optimize the usage of one of the at least first build material supply and second build material supply.

7. An apparatus as claimed in claim 1, wherein the print job characteristics include print volume and surface area.

8. An apparatus as claimed in claim 1, wherein the processor inputs further comprise user specific usage factors.

9. An apparatus as claimed in claim 1, further comprising a 3D printer to build a 3D print with the build material from the material mixer.

10. A method comprising:
receiving a 3D print job;
providing at least a first build material supply and a second build material supply material;
determining a mixing ratio of the at least first material supply and the at least second material supply based on inputs indicating at least print job characteristics and material constraints;
mixing build material in accordance with the mixing ratio; and
supplying the mixed build material to a build unit of a 3D printer.

11. A method as claimed in claim 9, further comprising measuring current build material availability.

12. A method as claimed in claim 9, further comprising estimating the quantity of build material for the print job.

13. A method as claimed in claim 9, wherein determining the mixing ratio includes optimizing the ratio to manage the usage of one of the at least first build material supply and second build material supply.

14. A machine readable storage medium comprising instructions executable by a processor to:
receive a 3D print job;
determine the mixing ratio of at least a first build material and a second build material based on inputs indicating at least print job characteristics and material constraints; and
instruct the supply of mixed print material to the build unit of a 3D printer based upon said mixing ratio.

15. A machine readable storage medium as claimed in claim 14, wherein in determining the mixing ratio the processor optimizes the mixing ratio to manage the usage of one of the at least first build material supply and second build material supply.
